(19) United States
(12) Patent Application Publication
(10) Pub. No.: US 2017/0362550 A1
(43) Pub. Date: Dec. 21, 2017

(54) CLEANING POUCH

(71) Applicant: The Procter & Gamble Company, Cincinnati, OH (US)

(72) Inventors: Elena ALDA RODRIGUEZ, Newcastle upon Tyne (GB); Lindsay Suzanne BEWICK, Tyne & Wear (GB); Alan Thomas BROOKER, Newcastle upon Tyne (GB); Nigel Patrick SOMERVILLE ROBERTS, Newcastle upon Tyne (GB); Philip Frank SOUTER, Northumberland (GB); Euan Campbell STRACHAN, Newcastle upon Tyne (GB)

(21) Appl. No.: 15/619,565

(22) Filed: Jun. 12, 2017

(30) Foreign Application Priority Data
Jun. 17, 2016 (EP) 16175140.9

(51) Int. Cl. C11D 17/04; B65D 65/46; C11D 3/37; C11D 3/20; B65B 7/02; C11D 11/00; C11D 3/33; B65B 3/04; C11D 7/32

(52) U.S. Cl. CPC C11D 17/043; B65B 7/02; B65D 65/46; C11D 17/045; C11D 3/3765; C11D 11/0023; C11D 3/2079; B65B 3/04; C11D 7/3245; C11D 3/33

(57) ABSTRACT

Pouch including a cleaning composition, the pouch includes a compartment housing a liquid composition, the liquid composition includes a liquid soil-suspension polymer.

### TECHNICAL FIELD

The present invention is in the field of cleaning. It relates to a cleaning product, in particular a cleaning product in the form of a pouch comprising at least one compartment containing a liquid composition, the liquid composition comprising a liquid soil-suspension polymer.

### BACKGROUND OF THE INVENTION

The detergent formulator is constantly facing cleaning and stability issues. Unit dose products can be more challenging than loose powders or liquids. Detergents in unit dose form have associated constrains in terms of volume that imply limitations in terms of the amount of actives.

Most if not all the cleaning ingredients can be susceptible to degradation to a greater or lesser extent. In unit dose products the different ingredients are in close proximity to one another this can negatively affect the stability of the product. The current trend is to reduce the size of the unit dose products making the cleaning and stability issues more of a challenge.

Another added complication that the detergent formulator faces is that different actives can be in different physical forms, some actives are in liquid form and some others in solid form. In order to have a cleaning composition in one physical form processing of ingredients in a different form is required. For example, organic dispersants such as organic polymers and organic builders are usually synthesized in aqueous solution. A great deal of work and high cost is associated with the transformation of these materials into particles in order to introduce them into products in solid form.

In recent years cleaning and stability of cleaning products have been impacted by the tendency to eliminate phosphate from cleaning formulations. Phosphate is not only an excellent cleaning active but also contributes to product stability by adsorbing moisture from the surrounding environment and/or from the product itself.

Another problem associated with unit-dose products, in particular with water-soluble pouches comprising a cleaning composition and an enveloping material is the interaction between the cleaning composition and the enveloping material. The enveloping material is water-soluble and usually contains a certain amount of water thus the presence of water in the cleaning composition could affect the integrity and properties of the film.

A further problem associated with multi-compartment pouches, is that the enveloping material is usually moisture permeable, allowing the transfer of moisture across compartments, negatively impacting on the stability of the product.

The objective of this invention is to provide a product that has a good environmental and cleaning profile, it is stable upon storage and it is favourable from a process viewpoint.

### SUMMARY OF THE INVENTION

According to a first aspect of the invention there is provided a pouch comprising a cleaning composition. Preferably, the composition is an automatic dishwashing detergent composition. In the pouch the composition is surrounded by an enveloping material. The enveloping material is preferably a water-soluble film. Both the cleaning composition and the enveloping material are water-soluble. They readily dissolve when exposed to water in an automatic dishwashing process, preferably during the main wash.

The pouch comprises a compartment housing a liquid composition, the liquid composition comprising a liquid soil-suspension polymer. By liquid polymer is herein meant a polymer that is flowable at temperatures below or equal to 25° C., i.e. the polymer is liquid at room temperature.

The “soil-suspension polymer” is sometimes referred herein as “the polymer of the invention”. A soil-suspension polymer is a polymer capable of boosting the soil-suspending capability of a cleaning composition as compared to the same amount of cleaning composition without the soil-suspension polymer. As soil is removed from a soiled surface there will be a tendency for it to coalesce into large aggregates that can re-deposit on the surface. In order to limit the coalesce, polymers, are added to the cleaning composition. Some soil-suspension polymers work by adsorbing the soil particles, increasing the net charge of the suspended soil. Electrostatic repulsion then becomes a limitation to the coalescence of the suspended soil into large aggregates and the soil remains suspended in the wash liquor. Other soil suspension polymers prevent soil coalescence via steric hindrance. Alkoxylated polyalkylenimine of general formula I have being found specially good to avoid coalesce of soils found on dishware.

Preferably the liquid composition has a relative humidity of less than about 65%, preferably less than 50% and especially less than 40% at 20° C.

Preferably the liquid composition comprises a surfactant system and the surfactant system preferably comprises a non-ionic surfactant and an esterified alkyl alkoxylated surfactant.

Preferably the pouch further comprises a compartment containing a solid composition comprising moisture-sensitive enzymes such as bleach and enzymes. An ingredient forming part of a cleaning composition is considered to be moisture-sensitive when it can be partially or fully degraded during storage by the interaction of moisture with the composition thereby decreasing the detergency activity of the ingredient as for example detergency bleach, enzymes, etc. The activity (i.e., cleaning capacity) of moisture-sensitive ingredients can decrease during storage when the cleaning composition is exposed to moisture.

Preferably, when there are more than one compartment, at least two of the compartments are in a superposed configuration, i.e., one above the other, thereby providing improved stability by reducing the area of the compartments directly exposed to the surrounding environment.

Preferably the cleaning composition has a pH as measured in 1% weight aqueous solution at 25° C. of from about 5 to about 7.5, preferably from 5.5 to 7 and preferably the composition is substantially free of builders and comprises bleach, enzymes, a pH regulator system, a crystal growth inhibitor, etc.

### DETAILED DESCRIPTION OF THE INVENTION

The present invention envisages a pouch comprising a cleaning composition, the pouch comprises a compartment housing a liquid composition, the liquid composition comprising a liquid soil-suspension polymer. The soil-suspension polymer is in liquid form and it does not bring moisture to the liquid composition. Moisture can affect the robustness of the pouch and can affect the physical and chemical stability of the composition, especially when the cleaning composition comprises moisture-sensitive components. The soil-suspension polymer preferably is an alkoxylated polyalkyleneimines having an inner polyethylene oxide block comprising 5 to 18 polyethylene oxide units, a middle polyalkylene oxide block comprising 1 to 5 polyalkylene oxide units and an outer polyethylene oxide block comprising 2 to 14 polyethylene oxide units.

### Equilibrium Relative Humidity

Equilibrium relative humidity “eRH” measures the vapour pressure generated by the moisture present in a composition. It can be expressed as:

eRH=100×Aw

Wherein Aw is water activity:

Aw=p/ps, where:

p: partial pressure of water vapour at the surface of the composition.

ps: saturation pressure, or the partial pressure of water vapour above pure water at the composition temperature.

Water activity reflects the active part of moisture content or the part which, under the established conditions (20° C.), can be exchanged between a composition and its environment.

The eRH is measured after the pouch has been conditioned by subjecting it to 60% relative humidity at 20° C. for two weeks.

For the purpose of this invention all the measurements are taken at atmospheric pressure unless stated otherwise.

The eRH can be measured using any commercially available equipment, such as a water activity meter (Rotronic A2101).

Soil-Suspension Polymer

It has been found that the shortcomings of ethoxylated polyalkyleneimines, such as a polyamine in which the backbone is modified by about fourteen or more polyethylene oxide units per nitrogen atom, e.g., having a melting point above room temperature, may be overcome by adding a middle block of propylene oxide, butylene oxide and/or pentene oxide to the polyethylene oxide block that is condensed with the polyamine backbone of the polyalkylenimine The resulting ethoxylated polyaklyenimine may be formulated into a cleaning composition, preferably into a liquid composition.

Cleaning compositions of the present disclosure may comprise a water-soluble alkoxylated polyalkylenimine of the general formula I

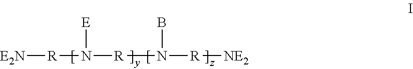

in which the variables are each defined as follows:
R represents identical or different, linear or branched C₂-C₁₂-alkylene radicals or an etheralkyl unit of formula X:

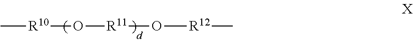

in which the variables are each defined as follows:
R¹⁰, R¹¹, R¹² represent identical or different, linear or branched C₂-C₆-alkylene radicals and d is an integer having a value in the range of from about 0 to about 50;
   B represents a continuation of the alkoxylated polyalkylenimine by branching;
   y is from about 0 to about 150, z is greater than 0 and less than or equal to about 150;
   E is an alkylenoxy unit of the formula II

CH₂CH₂OₘR¹—OₙCH₂CH₂OₚR² II
in which the variables are each defined as follows:
R¹ represents 1,2-propylene, 1,2-butylene and/or 1,2-pentene;
R² represents hydrogen and/or C₁-C₂₂-alkyl and/or C₇-C₂₂ aralkyl;
m is an integer having a value in the range of from about 5 to about 18;
n is an integer having a value in the range of from about 1 to about 5;
p is an integer having a value in the range of from about 2 to about 14.

In some examples, the sum of y+z is from about 1 to about 100, typically from about 1 to about 50, more typically from about 1 to about 20 or from about 1 to about 10.

In the above structure (I), the alkoxylated polyalkylenimine has an alkylenoxy unit (E) of the formula II, which comprises a middle polyalkylene oxide block, defined by (R¹—O)ₙ; it is considered “middle” because it is between two polyethylene oxide blocks, defined by (CH₂CH₂O)ₚ and (CH₂CH₂O)ₘ. One of the polyethylene oxide blocks may be an outer polyethylene oxide block, defined by (CH₂CH₂O)ₚ. One of the polyethylene oxide blocks may be an inner polyethylene oxide block, defined by (CH₂CH₂O)ₘ.

The inventive alkoxylated polyalkylenimines have a basic skeleton, e.g. a polyamine backbone, which comprises primary, secondary, and tertiary amino groups that are joined by alkylene radicals, R, and are in the form of the following moieties in random arrangement:
primary amino moieties that terminate the main chain and the side chains of the basic skeleton, the hydrogen atoms of which are subsequently replaced by alkylenoxy units:

[H₂N—R and —NH₂
secondary amino moieties, the hydrogen atom of which is subsequently replaced by alkylenoxy units:

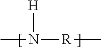

and tertiary amino moieties which branch the main chain and the side chains:

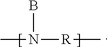

In some aspects, before the alkoxylation, the polyalkylenimine has a weight average molecular weight (M_{w}) of from about 50 g/mol to about 10 000 g/mol, typically from about 250 to about 10 000 g/mol. In some aspects, the weight average molecular weight M_{w} of the polyalkylenimine before the alkoxylation is from about 250 to about 5000 g/mol, or from about 400 to about 3000 g/mol, or from about 600 to about 1800 g/mol. The sum x+y+z of the repeating units of the primary, secondary and tertiary amino moieties means a total number of alkylenimine units which corresponds to these molecular weights.

In some aspects, the R radicals connecting the nitrogen atoms of the amino groups may be identical or different, linear or branched C₂-C₁₂-alkylene radicals, typically C₂-C₆-alkylene radicals. In some aspects, one or more of the R radicals is a branched C₂-C₆-alkylene radical. In certain aspects, one or more of the R radicals is 1,2-propylene. In some aspects, one or more of the R radicals is ethylene or hexamethylene.

The hydrogen atoms of the primary and secondary amino groups of the basic polyalkylenimine skeleton may be replaced by alkylenoxy units of the formula II

CH₂CH₂OₘR¹—OₙCH₂CH₂OₚR² II.

In formula II, the variables are each defined as follows:
R¹ represents 1,2-propylene, 1,2-butylene and/or 1,2-pentene;
R² represents hydrogen and/or C₁-C₂₂-alkyl and/or C₇-C₂₂ aralkyl;
m is an integer having a value in the range of from about 5 to about 18;
n is an integer having a value in the range of from about 1 to about 5;
p is an integer having a value in the range of from about 2 to about 14.

In some aspects, R² represents hydrogen and/or C₁-C₄-alkyl.

In some aspects, the modified polyalkyleneimine has the general structure of formula (III):

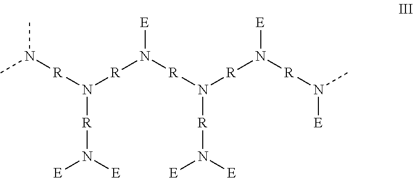

wherein the R groups are identical or different, linear or branched C₂-C₁₂-alkylene radicals, and

wherein E is an alkylenoxy unit of the formula II

CH₂CH₂OₘR¹—OₙCH₂CH₂OₚR² II
in which the variables are each defined as follows:
represents 1,2-propylene, 1,2-butylene and/or 1,2-pentene;
R² represents hydrogen and/or C₁-C₂₂-alkyl and/or C₇-C₂₂ aralkyl;
m is an integer having a value in the range of from about 5 to about 18;
n is an integer having a value in the range of from about 1 to about 5;
p is an integer having a value in the range of from about 2 to about 14.

In some aspects, the modified polyalkyleneimine has the general structure of formula (IV),

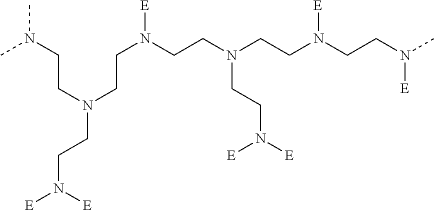

wherein E is an alkylenoxy unit of the formula II

CH₂CH₂OₘR¹—OₙCH₂CH₂OₚR² II
in which the variables are each defined as follows:
R¹ represents 1,2-propylene, 1,2-butylene and/or 1,2-pentene;
R² represents hydrogen and/or C₁-C₂₂-alkyl and/or C₇-C₂₂ aralkyl;
m is an integer having a value in the range of from about 5 to about 18;
n is an integer having a value in the range of from about 1 to about 5;
p is an integer having a value in the range of from about 2 to about 14.

In any of the above-described alkylenoxy units of Formula II, each of m and p may independently have a value in the range of from about 2 to about 18, or 5 to about 14. In some aspects, m+p is equal to or greater than about 14, or equal to or greater than about 16, or equal to or greater than about 20. In some aspects, m+p is from about 7 to about 50, or from about 14 to about 35, or from about 16 to about 30, or from about 20 to about 25, or about 21. In some aspects, n is from about 1 to about 5, or from about 2 to about 4.

In some aspects, the alkoxylated polyalkylenamines are liquid at or below room temperature, e.g., at or below 25° C. In some aspects, the alkoxylated polyalkylenamines have a melting point at or below about 25° C., or at or below about 20° C., or at or below about 15° C., or at or below about 10° C.

The alkoxylated polyalkylenimines may also be quaternized. A suitable degree of quaternization is up to about 100%, or from about 10 to about 95%. The alkoxylated polyalkylenimines may be quaternized by introducing C₁-C₂₂-alkyl groups, C₁-C₄-alkyl groups and/or C₇-C₂₂ aralkyl groups and may be performed in a customary manner by reaction with corresponding alkyl halides and dialkyl sulfates.

The quaternization of alkoxylated polyalkylenimines may be achieved by introducing C₁-C₂₂ alkyl, C₁-C₄-alkyl groups and/or C₇-C₂₂ aralkyl, aryl or alkylaryl groups and may be undertaken in a customary manner by reaction with corresponding alkyl-, aralkyl-halides and dialkylsulfates, as described for example in WO 09/060059.

Quaternization may be accomplished, for example, by reacting an alkoxylated polyalkylenimine with an alkylation agent such as a C₁-C₄-alkyl halide, for example with methyl bromide, methyl chloride, ethyl chloride, methyl iodide, n-butyl bromide, isopropyl bromide, or with an aralkyl halide, for example with benzyl chloride, benzyl bromide or with a di-C₁-C₂₂-alkyl sulfate in the presence of a base, especially with dimethyl sulfate or with diethyl sulfate. Suitable bases are, for example, sodium hydroxide and potassium hydroxide.

The amount of alkylating agent determines the amount of quaternization of the amino groups in the polymer, i.e. the amount of quaternized moieties. The amount of the quaternized moieties can be calculated from the difference of the amine number in the non-quaternized amine and the quaternized amine The amine number can be determined according to the method described in DIN 16945.

The reaction may be carried out without any solvent. However, a solvent or diluent like water, acetonitrile, dimethylsulfoxide, N-Methylpyrrolidone, etc. may be used. The reaction temperature is usually in the range from 10° C. to 150° C. and is preferably from 50° C. to 100° C.

In some aspects, the inventive quaternized polyalkylenimines may be sulfatized or transsulfatized if R² in formula II is hydrogen. Typically, the inventive quaternized polyalkylenimines are sulfatized or transsulfatized. The quaternized polyalkylenimines can be sulfatized or transsulfatized in accordance with methods known in the art, e.g. as described in WO 05/092952. Sulfatation or transsulfatation can be achieved with e.g. dimethylsulfate.

The sulfation of the polymers according to the present invention can be affected by a reaction with sulfuric acid or with a sulfuric acid derivative. Suitable sulfation agents are e.g. sulfuric acid (preferably 75% to 100% strength, more preferably 85% to 98% strength), oleum, SO₃, chlorosulfonic acid, sulfuryl chloride, amidosulfuric acid, and the like. If sulfuryl chloride is being used as sulfation agent, the remaining chlorine is being replaced by hydrolysis after sulfation. The sulfation agent is frequently used in equimolar amounts or in excess, e.g. 1 to 1.5 moles per OH-group present in the polymer. But, the sulfation agent can also be used in sub-equimolar amounts. The sulfation can be effected in the presence of a solvent. A suitable solvent is e.g. toluene. After the sulfation the reaction mixture is generally neutralized and worked up in a conventional manner

As described above, it is also possible to quaternize and transsulfatize alkoxylated polyalkylenimines. A sulfation process can be described as transsulfation process, when an alkoxylated polyalkylenimine is first reacted with a di-C₁-C₄-alkyl sulfate to form a quaternized polyalkylenimine and a sulfating species as counterion, and then followed by reacting the hydroxyl groups with the sulfating species, leading to a quaternized and sulfated alkoxylated polyalkylenimine. Examples for transsulfation processes are described in WO 04/024858 or WO 02/12180.

Combined quaternization and sulfatization can be achieved, e.g., by first reacting an alkoxylated polyalkylenimine with a di-C₁-C₄-alkyl sulfate in the presence of a base, then acidifying the reaction mixture obtained from quaternization, for example with an organic acid, such as methane sulfonic acid, or with a mineral acid such as phosphoric acid, sulfuric acid or hydrochloric acid. The process is conducted at a pH less than 6, preferably less than pH 3, at temperatures from 0° C.-200° C., preferably 50-150° C. After the transsulfation the reaction mixture is generally neutralized.

In some aspects, the alkoxylated polyalkylenimine is additionally quaternized and/or sulfatized.

The alkoxylated polyalkylenimines may be prepared in a known manner. One typical procedure consists in initially undertaking only an incipient alkoxylation of the polyalkylenimine in a first step. Thus, the present invention further relates to a process for preparing a water-soluble alkoxylated polyalkyleneimine according to the present invention, wherein a polyalkyleneimine is first reacted with ethylene oxide, then with propylene oxide or butylene oxide, and then with ethylene oxide.

In the first step, the polyalkylenimine is reacted only with a portion of the total amount of ethylene oxide used, which corresponds to about 1 mol of ethylene oxide per mole of NH moiety.

In some aspects, per mol of N—H functionalities in the polyalkyleneimine, the polyalkyleneimine is reacted with 5 to 18 moles ethylene oxide, then with 1 to 5 moles propylenoxide or butylene oxide, and then with 2 to 14 moles ethylene oxide.

In certain aspects, the polyalkylenimine is a polyethyleneimine

This reaction is undertaken generally in the absence of a catalyst in aqueous solution at from about 70 to about 200° C., or from about 80 to about 160° C., under a pressure of up to about 10 bar, in particular up to about 8 bar.

In a second step, the further alkoxylation is then performed by subsequent reaction i) with the remaining amount of ethylene oxide; ii) with propylene oxide or, in the case of a modification by a higher alkylene oxide, with butylene oxide and/or pentene oxide; and, finally, iii) with ethylene oxide.

The second step of the alkoxylation reaction is undertaken typically in the presence of a basic catalyst. Examples of suitable catalysts are alkali metal and alkaline earth metal hydroxides, such as sodium hydroxide, potassium hydroxide and calcium hydroxide, alkali metal alkoxides, in particular sodium and potassium C₁-C₄-alkoxides, such as sodium methoxide, sodium ethoxide and potassium tert-butoxide, alkali metal and alkaline earth metal hydrides such as sodium hydride and calcium hydride, and alkali metal carbonates such as sodium carbonate and potassium carbonate. In some aspects, the basic catalyst is selected from the alkali metal hydroxides or the alkali metal alkoxides, in particular potassium hydroxide or sodium hydroxide. Typical use amounts for the basic catalyst are from about 0.05 to aboutl0% by weight, in particular from about 0.5 to about 2% by weight, based on the total amount of polyalkylenimine and alkylene oxide.

The further alkoxylation may be undertaken in substance (variant a)) or in an organic solvent (variant b)). The process conditions specified below may be used both for steps of the alkoxylation reaction.

In variant a), the aqueous solution of the incipiently alkoxylated polyalkylenimine obtained in the first step, after addition of the catalyst, is initially dewatered. This can be done in a simple manner by heating to from about 80 to about 150° C. and distilling off the water under a reduced pressure of less than about 30 mbar. The subsequent reactions with the alkylene oxides are performed typically at from about 70 to about 200° C., or from about 100 to about 180° C., and at a pressure of up to about 10 bar, in particular up to about 8 bar, and a continued stirring time of about 0.5 to about 4 h at from about 100 to about 160° C. and constant pressure follows in each case.

Suitable reaction media for variant b) are in particular nonpolar and polar aprotic organic solvents. Examples of particularly suitable nonpolar aprotic solvents include aliphatic and aromatic hydrocarbons such as hexane, cyclohexane, toluene and xylene. Examples of particularly suitable polar aprotic solvents are ethers, in particular cyclic ethers, such as tetrahydrofuran and dioxane, N,N-dialkylamides such as dimethylformamide and dimethylacetamide, and N-alkyllactams such as N-methylpyrrolidone. It is also possible to use mixtures of these aprotic solvents. Particularly suitable solvents are xylene and toluene.

In variant b) too, the solution obtained in the first step, after addition of catalyst and solvent, is initially dewatered, which is advantageously done by separating out the water at a temperature of from about 120 to about 180° C., typically supported by a gentle nitrogen stream. The subsequent reaction with the alkylene oxide may be performed as in variant a).

In variant a), the alkoxylated polyalkylenimine is obtained directly in substance and may be converted if desired to an aqueous solution. In variant b), the organic solvent is typically removed and replaced by water. The products may also be isolated in substance.

In some aspects, the inventive polymers have a melting point lower than 25° C., so that they are liquid at room temperature. This enables easier handling since they do not have to be melted or solubilized in aqueous solution before further processing.

In some aspects, the alkoxylated polyalkylenimines have a weight average molecular weight of from about 1500 to about 100,000 g/mol, or from about 5000 to about 50,000 g/mol, or from about 10,000 to about 40,000 g/mol, or from about 20,000 to about 30,000 g/mol.

The alkoxylated polyalkylenimines may be present in a cleaning composition at a concentration of from about 0.1% to about 5% by weight of the composition, or at a concentration of from about 0.5% to about 2% by weight of the composition. The liquid composition comprises from about 10% to about 50%, preferably from about 15% to about 35% by weight of the composition of alkoxylated polyalkylenimines

### Cleaning Composition

Preferably, the composition of the invention is an automatic dishwashing composition. Typical automatic dishwashing products are formulated such that a 1% solution of the product has a pH of between 9 and 11.5 at 25° C. This is because in order to effectively clean the items found within the dishwasher and minimize the number of residues found in the machine filter, an automatic dishwashing product is formulated at high pH in order to effectively hydrate and swell soils, provide a pH range in which bleaches are effective (the hydroperoxide anion is a valuable bleaching species, either on its own or as a means to perhydrolyze a bleach activator such as TAED) and a pH in which triglyceride grease soils are effectively hydrolyzed. Such compositions are well optimized to provide cleaning and lack of film on the washes items but still the washed items can present spots that can connote lack of cleaning.

It has surprisingly been found that by formulating a neutral or acidic automatic dishwashing detergent composition comprising the soil-suspension polymer of the invention, the composition provides good cleaning and good finishing (including filming and spotting reduction) and it is stable.

### pH Regulator System

The benefits provided by the composition of the invention are linked to the low pH of the wash liquor provided by the composition of the invention. It is not sufficient to provide a composition presenting a low pH when dissolved in deionised water what is important is that the low pH of the composition is maintained during the duration of the wash.

In the process of dishwashing, the water and the different ions coming from the soils can destabilise the pH of the composition. In order to maintain the composition at low pH a pH regulator system capable of maintaining the low pH during the wash is needed. The pH regulator system provides the right pH and it has buffering capacity to maintain this pH. A pH regulator system can be created either by using a mixture of an acid and its anion, such as a citrate salt and citric acid, or by using a mixture of the acid form (citric acid) with a source of alkalinity (such as a hydroxide, bicarbonate or carbonate salt) or by using the anion (sodium citrate) with a source of acidity (such as sodium bisulphate). Suitable pH regulator systems comprise mixtures of organic acids, preferably polycarboxylic acids and their salts, more preferably citric acid and citrate.

Preferably the composition of the invention comprises from about 1% to about 60%, more preferably from about 10% to about 40% by weight of the composition of a pH regulator system, preferably selected from citric acid, citrate and mixtures thereof.

### Builder

Preferably, the composition of the invention is substantially builder free, i.e. comprises less than about 10%, preferably less than about 5%, more preferably less than about 1% and especially less than about 0.1% of builder by weight of the composition. Builders are materials that sequester hardness ions, particularly calcium and/or magnesium. Strong calcium builders are species that are particularly effective at binding calcium and exhibit strong calcium binding constants, particularly at high pHs.

For the purposes of this patent a “builder” is a strong calcium builder. A strong calcium builder can consist of a builder that when present at 0.5 mM in a solution containing 0.05 mM of Fe(III) and 2.5 mM of Ca(II) will selectively bind the calcium ahead of the iron at one or more of pHs 6.5 or 8 or 10.5. Specifically, the builder when present at 0.5 mM in a solution containing 0.05 mM of Fe(III) and 2.5 mM of Ca(II) will bind less than 50%, preferably less than 25%, more preferably less than 15%, more preferably less than 10%, more preferably less than 5%, more preferably less than 2% and specially less than 1% of the Fe(III) at one or preferably more of pHs 6.5 or 8 as measured at 25° C. The builder will also preferably bind at least 0.25 mM of the calcium, preferably at least 0.3 mM, preferably at least 0.4 mM, preferably at least 0.45 mM, preferably at least 0.49 mM of calcium at one or more of pHs 6.5 or 8 or 10.5 as measured at 25° C.

The most preferred strong calcium builders are those that will bind calcium with a molar ratio (builder:calcium) of less than 2.5:1, preferably less than 2:1, preferably less than1.5:1 and most preferably as close as possible to 1:1, when equal quantities of calcium and builder are mixed at a concentration of 0.5 mM at one or more of pHs 6.5 or 8 or 10.5 as measured at 25° C.

Examples of strong calcium builders include phosphate salts such as sodium tripolyphosphate, amino acid-based builders such as amino acid based compounds, in particular MGDA (methyl-glycine-diacetic acid), and salts and derivatives thereof, GLDA (glutamic-N,N-diacetic acid) and salts and derivatives thereof, IDS (iminodisuccinic acid) and salts and derivatives thereof, carboxy methyl inulin and salts and derivatives thereof and mixtures thereof.

Other builders include amino acid based compound or a succinate based compound. Other suitable builders are described in U.S. Pat. No. 6,426,229. In one aspect, suitable builders include; for example, aspartic acid-N-monoacetic acid (ASMA), aspartic acid-, -diacetic acid (ASDA), aspartic acid-N-monopropionic acid (ASMP), iminodisuccinic acid (IDA), N-(2-sulfomethyl) aspartic acid (SMAS), N-(2-sulfoethyl) aspartic acid (SEAS), N-(2-sulfomethyl) glutamic acid (SMGL), N-(2-sulfoethyl) glutamic acid (SEGL), N-methyliminodiacetic acid (MID A), alpha-alanine-N,N-diacetic acid (alpha-ALDA), serine-, -diacetic acid (SEDA), isoserine-N,N-diacetic acid (ISDA), phenylalanine-N,N-diacetic acid (PHDA), anthranilic acid-N,N-diacetic acid (ANDA), sulfanilic acid-N, N-diacetic acid (SLDA), taurine-N, N-diacetic acid (TUDA) and sulfomethyl-N,N-diacetic acid (SMDA) and alkali metal salts or ammonium salts thereof.

Polycarboxylic acids and their salts do not act as builders at the pH of the present invention and therefore are not to be considered as builder within the meaning of the invention. Polycarboxylic acids and their salts are considered a pH regulator system within the meaning of the invention.

### Iron Chelant

The composition of the invention preferably comprises an iron chelant at a level of from about 0.1% to about 5%, preferably from about 0.2% to about 2%, more preferably from about 0.4% to about 1% by weight of the composition.

As commonly understood in the detergent field, chelation herein means the binding or complexation of a bi- or multi-dentate ligand. These ligands, which are often organic compounds, are called chelants, chelators, chelating agents, and/or sequestering agent. Chelating agents form multiple bonds with a single metal ion. Chelants form soluble, complex molecules with certain metal ions, inactivating the ions so that they cannot normally react with other elements or ions to produce precipitates or scale. The ligand forms a chelate complex with the substrate. The term is reserved for complexes in which the metal ion is bound to two or more atoms of the chelant.

The composition of the present invention is preferably substantially free of builders and preferably comprises an iron chelant. An iron chelant has a strong affinity (and high binding constant) for Fe(III).

It is to be understood that chelants are to be distinguished from builders. For example, chelants are exclusively organic and can bind to metals through their N,P,O coordination sites or mixtures thereof while builders can be organic or inorganic and, when organic, generally bind to metals through their O coordination sites. Moreover, the chelants typically bind to transition metals much more strongly than to calcium and magnesium; that is to say, the ratio of their transition metal binding constants to their calcium/magnesium binding constants is very high. By contrast, builders herein exhibit much less selectivity for transition metal binding, the above-defined ratio being generally lower.

The chelant in the composition of the invention is a selective strong iron chelant that will preferentially bind with iron (III) versus calcium in a typical wash environment where calcium will be present in excess versus the iron, by a ratio of at least 10:1, preferably greater than 20:1.

The iron chelant when present at 0.5 mM in a solution containing 0.05 mM of Fe(III) and 2.5 mM of Ca(II) will fully bind at least 50%, preferably at least 75%, more preferably at least 85%,more preferably at least 90%, more preferably at least 95%, more preferably at least 98% and specially at least 99% of the Fe(III) at one or preferably more of pHs 6.5 or 8 as measured at 25° C. The amount of Fe(III) and Ca(II) bound by a builder or chelant is determined as explained herein below

### Method for Determining Competitive Binding

To determine the selective binding of a specific ligand to specific metal ions, such as iron(III) and calcium (II), the binding constants of the metal ion-ligand complex are obtained via reference tables if available, otherwise they are determined experimentally. A speciation modeling simulation can then be performed to quantitatively determine what metal ion-ligand complex will result under a specific set of conditions.

As used herein, the term “binding constant” is a measurement of the equilibrium state of binding, such as binding between a metal ion and a ligand to form a complex. The binding constant K_{bc} (25° C. and an ionic strength (I) of 0.1 mol/L) is calculated using the following equation:

K_{bc}=[MLₓ]/([M][L]^{x})

where [L] is the concentration of ligand in mol/L, x is the number of ligands that bond to the metal, [M] is the concentration of metal ion in mol/L, and [MLₓ] is the concentration of the metal/ligand complex in mol/L.

Specific values of binding constants are obtained from the public database of the National Institute of Standards and Technology (“NIST”), R. M. Smith, and A. E. Martell, NIST Standard Reference Database 46, NIST Critically Selected Stability Constants of Metal Complexes: Version 8.0, May 2004, U.S. Department of Commerce, Technology Administration, NIST, Standard Reference Data Program, Gaithersburg, Md. If the binding constants for a specific ligand are not available in the database then they are measured experimentally.

Once the appropriate binding constants have been obtained, a speciation modeling simulation can be performed to quantitatively determine what metal ion-ligand complex will result under a specific set of conditions including ligand concentrations, metal ion concentrations, pH, temperature and ionic strength. For simulation purposes, NIST values at 25° C. and an ionic strength (I) of 0.1 mol/L with sodium as the background electrolyte are used. If no value is listed in NIST the value is measured experimentally. PHREEQC from the US Geological Survey, http://wwwbrr.cr.usgs.gov/projects/GWC_coupled/phreeqc/. PHREEQC is used for speciation modeling simulation.

Iron chelants include those selected from siderophores, catechols, enterobactin, hydroxamates and hydroxypyridinones or hydroxypyridine N-Oxides. Preferred chelants include anionic catechols, particularly catechol sulphonates, hydroxamates and hydroxypyridine N-Oxides. Preferred strong chelants include hydroxypridine N-Oxide (HPNO), Octopirox, and/or Tiron (disodium 4,5-dihydroxy-1,3-benzenedisulfonate), with Tiron, HPNO and mixtures thereof as the most preferred for use in the composition of the invention. HPNO within the context of this invention can be substituted or unsubstituted. Numerous potential and actual resonance structures and tautomers can exist. It is to be understood that a particular structure includes all of the reasonable resonance structures and tautomers.

### Bleach

The composition of the invention preferably comprises from 1% to 40% by weight of the composition of bleach, more preferably from 5 to 15% by weight of the composition of bleach. Sodium percarbonate is the preferred bleach for use herein.

Inorganic and organic bleaches are suitable for use herein. Inorganic bleaches include perhydrate salts such as perborate, percarbonate, perphosphate, persulfate and persilicate salts. The inorganic perhydrate salts are normally the alkali metal salts. The inorganic perhydrate salt may be included as the crystalline solid without additional protection. Alternatively, the salt can be coated. Suitable coatings include sodium sulphate, sodium carbonate, sodium silicate and mixtures thereof. Said coatings can be applied as a mixture applied to the surface or sequentially in layers.

Alkali metal percarbonates, particularly sodium percarbonate is the preferred bleach for use herein. The percarbonate is most preferably incorporated into the products in a coated form which provides in-product stability.

### Potassium Peroxymonopersulfate is Another Inorganic Perhydrate Salt of Utility Herein.

Typical organic bleaches are organic peroxyacids, especially diperoxydodecanedioc acid, diperoxytetradecanedioc acid, and diperoxyhexadecanedioc acid. Mono- and diperazelaic acid, mono- and diperbrassylic acid are also suitable herein. Diacyl and Tetraacylperoxides, for instance dibenzoyl peroxide and dilauroyl peroxide, are other organic peroxides that can be used in the context of this invention.

Further typical organic bleaches include the peroxyacids, particular examples being the alkylperoxy acids and the arylperoxy acids. Preferred representatives are (a) peroxybenzoic acid and its ring-substituted derivatives, such as alkylperoxybenzoic acids, but also peroxy-α-naphthoic acid and magnesium monoperphthalate, (b) the aliphatic or substituted aliphatic peroxy acids, such as peroxylauric acid, peroxystearic acid, ε-phthalimidoperoxycaproic acid[phthaloiminoperoxyhexanoic acid (PAP)], o-carboxybenzamidoperoxycaproic acid, N-nonenylamidoperadipic acid and N-nonenylamidopersuccinates, and (c) aliphatic and araliphatic peroxydicarboxylic acids, such as 1,12-diperoxycarboxylic acid, 1,9-diperoxyazelaic acid, diperoxysebacic acid, diperoxybrassylic acid, the diperoxyphthalic acids, 2-decyldiperoxybutane-1,4-dioic acid, N,N-terephthaloyldi(6-aminopercaproic acid).

Preferably, the level of bleach in the composition of the invention is from about 0 to about 10%, more preferably from about 0.1 to about 5%, even more preferably from about 0.5 to about 3% by weight of the composition. When the pouch of the invention comprises bleach the bleaching benefit is booster by the soil-suspension polymer.

### Crystal Growth Inhibitor

Crystal growth inhibitors are materials that can bind to calcium carbonate crystals and prevent further growth of species such as aragonite and calcite.

### Examples of Effective Crystal Growth Inhibitors Include Phosphonates, Polyphosphonates, Inulin Derivatives and Cyclic Polycarboxylates.

Suitable crystal growth inhibitors may be selected from the group comprising HEDP (1-hydroxyethylidene 1,1-diphosphonic acid), carboxymethylinulin (CMI), tricarballylic acid and cyclic carboxylates. For the purposes of this invention the term carboxylate covers both the anionic form and the protonated carboxylic acid form.

Cyclic carboxylates contain at least two, preferably three or preferably at least four carboxylate groups and the cyclic structure is based on either a mono- or bi-cyclic alkane or a heterocycle. Suitable cyclic structures include cyclopropane, cyclobutane, cyclohexane or cyclopentane or cycloheptane, bicyclo-heptane or bicyclo-octane and/or tetrhaydrofuran. One preferred crystal growth inhibitor is cyclopentane tetracarboxylate.

Cyclic carboxylates having at least 75%, preferably 100% of the carboxylate groups on the same side, or in the “cis” position of the 3D-structure of the cycle are preferred for use herein.

It is preferred that the two carboxylate groups, which are on the same side of the cycle are in directly neighbouring or “ortho” positions

Preferred crystal growth inhibitors include HEDP, tricarballylic acid, tetrahydrofurantetracarboxylic acid (THFTCA) and cyclopentanetetracarboxylic acid (CPTCA). The THFTCA is preferably in the 2c,3t,4t,5c-configuration, and the CPTCA in the cis,cis,cis,cis-configuration.

The crystal growth inhibitors are present preferably in a quantity from about 0.01 to about 10%, particularly from about 0.02 to about 5% and in particular from 0.05 to 3% by weight of the composition.

### Carboxylated/Sulfonated Polymers

Suitable carboxylated/sulfonated polymers described herein may have a weight average molecular weight of less than or equal to about 100,000 Da, preferably less than or equal to about 75,000 Da, more preferably less than or equal to about 50,000 Da, more preferably from about 3,000 Da to about 50,000, and specially from about 5,000 Da to about 45,000 Da.

Preferred carboxylic acid monomers include one or more of the following: acrylic acid, maleic acid, itaconic acid, methacrylic acid, or ethoxylate esters of acrylic acids, acrylic and methacrylic acids being more preferred. Preferred sulfonated monomers include one or more of the following: sodium (meth) allyl sulfonate, vinyl sulfonate, sodium phenyl (meth) allyl ether sulfonate, or 2-acrylamido-methyl propane sulfonic acid. Preferred non-ionic monomers include one or more of the following: methyl (meth) acrylate, ethyl (meth) acrylate, t-butyl (meth) acrylate, methyl (meth) acrylamide, ethyl (meth) acrylamide, t-butyl (meth) acrylamide, styrene, or α-methyl styrene.

In the polymers, all or some of the carboxylic or sulfonic acid groups can be present in neutralized form, i.e. the acidic hydrogen atom of the carboxylic and/or sulfonic acid group in some or all acid groups can be replaced with metal ions, preferably alkali metal ions and in particular with sodium ions.

Preferred commercial available polymers include: Alcosperse 240, Aquatreat AR 540 and Aquatreat MPS supplied by Alco Chemical; Acumer 3100, Acumer 2000, Acusol 587G and Acusol 588G supplied by Rohm & Haas; Goodrich K-798, K-775 and K-797 supplied by BF Goodrich; and ACP 1042 supplied by ISP technologies Inc. Particularly preferred polymers are Acusol 587G and Acusol 588G supplied by Rohm & Haas, Versaflex Si™ (sold by Alco Chemical, Tennessee, USA) and those described in U.S. Pat. No. 5,308,532 and in WO 2005/090541.

Suitable styrene co-polymers may be selected from the group comprising, styrene co-polymers with acrylic acid and optionally sulphonate groups, having average molecular weights in the range 1,000-50,000, or even 2,000-10,000 such as those supplied by Alco Chemical Tennessee, USA, under the tradenames Alcosperse® 729 and 747.

### Non-Ionic Surfactants

Suitable for use herein are non-ionic surfactants, they can acts as anti-redeposition agents. Preferably, the composition comprises a non-ionic surfactant or a non-ionic surfactant system having a phase inversion temperature, as measured at a concentration of 1% in distilled water, between 40 and 70° C., preferably between 45 and 65° C. By a “non-ionic surfactant system” is meant herein a mixture of two or more non-ionic surfactants. Preferred for use herein are non-ionic surfactant systems. They seem to have improved cleaning and finishing properties and stability in product than single non-ionic surfactants.

Phase inversion temperature is the temperature below which a surfactant, or a mixture thereof, partitions preferentially into the water phase as oil-swollen micelles and above which it partitions preferentially into the oil phase as water swollen inverted micelles. Phase inversion temperature can be determined visually by identifying at which temperature cloudiness occurs.

The phase inversion temperature of a non-ionic surfactant or system can be determined as follows: a solution containing 1% of the corresponding surfactant or mixture by weight of the solution in distilled water is prepared. The solution is stirred gently before phase inversion temperature analysis to ensure that the process occurs in chemical equilibrium. The phase inversion temperature is taken in a thermostable bath by immersing the solutions in 75 mm sealed glass test tube. To ensure the absence of leakage, the test tube is weighed before and after phase inversion temperature measurement. The temperature is gradually increased at a rate of less than 1° C. per minute, until the temperature reaches a few degrees below the pre-estimated phase inversion temperature. Phase inversion temperature is determined visually at the first sign of turbidity.

Suitable nonionic surfactants include: i) ethoxylated non-ionic surfactants prepared by the reaction of a monohydroxy alkanol or alkyphenol with 6 to 20 carbon atoms with preferably at least 12 moles particularly preferred at least 16 moles, and still more preferred at least 20 moles of ethylene oxide per mole of alcohol or alkylphenol; ii) alcohol alkoxylated surfactants having a from 6 to 20 carbon atoms and at least one ethoxy and propoxy group. Preferred for use herein are mixtures of surfactants i) and ii).

Another suitable non-ionic surfactants are epoxy-capped poly(oxyalkylated) alcohols represented by the formula:

R₁O[CH₂CH(CH₃)O]ₓ[CH₂CH₂O]_{y}[CH₂CH(OH)R₂] (I)

wherein R₁ is a linear or branched, aliphatic hydrocarbon radical having from 4 to 18 carbon atoms; R₂ is a linear or branched aliphatic hydrocarbon radical having from 2 to 26 carbon atoms; x is an integer having an average value of from 0.5 to 1.5, more preferably about 1; and y is an integer having a value of at least 15, more preferably at least 20.

Preferably non-ionic surfactants and/or system to use as anti-redeposition agents herein have a Draves wetting time of less than 360 seconds, preferably less than 200 seconds, more preferably less than 100 seconds and especially less than 60 seconds as measured by the Draves wetting method (standard method ISO 8022 using the following conditions; 3-g hook, 5-g cotton skein, 0.1% by weight aqueous solution at a temperature of 25° C.).

Preferred non-ionic surfactants for use herein are selected from the group consisting of:
a) a non-ionic surfactant of formula RO(CH2CH2O)xH wherein where R is iso-C13H27 and x is 7;
b) a non-ionic surfactant of formula RO(CH2CH2O)x(CH2CH2CH2O)yH wherein where R is a C6-C14 alkyl and x and y are from 5 to 20; and
c) mixtures thereof.
   A mixture of a) and b) is especially preferred for use herein.

Amine oxides surfactants are also useful in the present invention as anti-redeposition surfactants include linear and branched compounds having the formula:

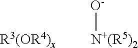

wherein R³ is selected from an alkyl, hydroxyalkyl, acylamidopropoyl and alkyl phenyl group, or mixtures thereof, containing from 8 to 26 carbon atoms, preferably 8 to 18 carbon atoms; R⁴ is an alkylene or hydroxyalkylene group containing from 2 to 3 carbon atoms, preferably 2 carbon atoms, or mixtures thereof; x is from 0 to 5, preferably from 0 to 3; and each R⁵ is an alkyl or hydroxyalkyl group containing from 1 to 3, preferably from 1 to 2 carbon atoms, or a polyethylene oxide group containing from 1 to 3, preferable 1, ethylene oxide groups. The R⁵ groups can be attached to each other, e.g., through an oxygen or nitrogen atom, to form a ring structure.

These amine oxide surfactants in particular include C₁₀-C₁₈ alkyl dimethyl amine oxides and C₈-C₁₈ alkoxy ethyl dihydroxyethyl amine oxides. Examples of such materials include dimethyloctylamine oxide, diethyldecylamine oxide, bis-(2-hydroxyethyl)dodecylamine oxide, dimethyldodecylamine oxide, dipropyltetradecylamine oxide, methylethylhexadecylamine oxide, dodecylamidopropyl dimethylamine oxide, cetyl dimethylamine oxide, stearyl dimethylamine oxide, tallow dimethylamine oxide and dimethyl-2-hydroxyoctadecylamine oxide. Preferred are C₁₀-C₁₈ alkyl dimethylamine oxide, and C₁₀₋₁₈ acylamido alkyl dimethylamine oxide.

Non-ionic surfactants may be present in amounts from 0 to 20%, preferably from 1% to 15%, and most preferably from 2% to 12% by weight of the composition.

### Esterified Alkyl Alkoxylated Surfactant

### The Detergent Composition of the Invention Can Comprise an Esterified Alkyl Alkoxylated of General Formula (I)

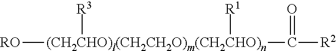 [0156] wherein
R is a branched or unbranched alkyl radical having 8 to 16 carbon atoms;
R3, R1 independently of one another, are hydrogen or a branched or unbranched alkyl radical having 1 to 5 carbon atoms;
R2 is an unbranched alkyl radical having 5 to 17 carbon atoms;
l, n independently of one another, are a number from 1 to 5 and
m is a number from 13 to 35;

Preferably, the radical R is a branched alkyl radical having 9 to 16, more preferably having 10 to 13, carbon atoms. The degree of branching is preferably 1-3. For the purposes of the present invention, the term “degree of branching” is understood as meaning the number of methyl groups reduced by 1.

Further preferably, Ra, R1 independently of one another, are hydrogen, methyl and ethyl. If R3, R1 occur more frequently, then each can be chosen independently of a further R3 or R1. Thus Ra, R1 can occur blockwise or in random distribution.
R2 is preferably a branched or unbranched alkyl radical having 5 to 13 carbon atoms.
Preferably n=1, l=5 and m is preferably a number from 13 to 34, more preferably 13 to 33, even more preferably 13 to 30, most preferably 17 to 27.
Further preferably, the average molecular weight is in a range from 950 to 2300 g/mol. Particularly preferably, the average molecular weight is in a range from 1200 to 1900 g/mol.

The esterified alkyl alkoxylated surfactant of the invention is a low foaming surfactant. The esterified surfactant is stable in an alkaline environment. Preferably the esterified surfactant has a melting point above 25° C., more preferably above 35° C.

The esterified surfactant of the invention can be synthesized as described in US2008/0167215, paragraphs [0036] to [0042], herein included by reference.

Preferably the composition of the invention comprises enzymes, more preferably amylases and proteases.

### Enzyme-Related Terminology

### Nomenclature for Amino Acid Modifications

In describing enzyme variants herein, the following nomenclature is used for ease of reference: Original amino acid(s):position(s):substituted amino acid(s).

According to this nomenclature, for instance the substitution of glutamic acid for glycine in position 195 is shown as G195E. A deletion of glycine in the same position is shown as G195*, and insertion of an additional amino acid residue such as lysine is shown as G195GK. Where a specific enzyme contains a “deletion” in comparison with other enzyme and an insertion is made in such a position this is indicated as *36D for insertion of an aspartic acid in position 36. Multiple mutations are separated by pluses, i.e.: S99G+V102N, representing mutations in positions 99 and 102 substituting serine and valine for glycine and asparagine, respectively. Where the amino acid in a position (e.g. 102) may be substituted by another amino acid selected from a group of amino acids, e.g. the group consisting of N and I, this will be indicated by V102N/I.

In all cases, the accepted IUPAC single letter or triple letter amino acid abbreviation is employed.

Where multiple mutations are employed they are shown with either using a “+” or a “/”, so for instance either S126C+P127R+S128D or S126C/P127R/S128D would indicate the specific mutations shown are present in each of positions 126, 127 and 128.

### Amino Acid Identity

The relatedness between two amino acid sequences is described by the parameter “identity”. For purposes of the present invention, the alignment of two amino acid sequences is determined by using the Needle program from the EMBOSS package (http://emboss.org) version 2.8.0. The Needle program implements the global alignment algorithm described in Needleman, S. B. and Wunsch, C. D. (1970) J. Mol. Biol. 48, 443-453. The substitution matrix used is BLOSUM62, gap opening penalty is 10, and gap extension penalty is 0.5.

The degree of identity between an amino acid sequence of an enzyme used herein (“invention sequence”) and a different amino acid sequence (“foreign sequence”) is calculated as the number of exact matches in an alignment of the two sequences, divided by the length of the “invention sequence” or the length of the “foreign sequence”, whichever is the shortest. The result is expressed in percent identity. An exact match occurs when the “invention sequence” and the “foreign sequence” have identical amino acid residues in the same positions of the overlap. The length of a sequence is the number of amino acid residues in the sequence.

### Protease

Preferred proteases for use herein have an isoelectric point of from about 4 to about 9, preferably from about 4 to about 8, most preferably from about 4.5 to about 6.5. Proteases with this isoelectric point present good activity in the wash liquor provided by the composition of the invention. As used herein, the term “isoelectric point” refers to electrochemical properties of an enzyme such that the enzyme has a net charge of zero as calculated by the method described below.

Preferably the protease of the composition of the invention is an endoprotease, by “endoprotease” is herein understood a protease that breaks peptide bonds of non-terminal amino acids, in contrast with exoproteases that break peptide bonds from their end-pieces.

### Isoelectric Point

The isoelectric point (referred to as IEP or pI) of an enzyme as used herein refers to the theoretical isoelectric point as measured according to the online pI tool available from ExPASy server at the following web address:
http://web.expasy.org/compute_pi/
The method used on this site is described in the below reference:
Gasteiger E., Hoogland C., Gattiker A., Duvaud S., Wilkins M. R., Appel R. D., Bairoch A.; Protein Identification and Analysis Tools on the ExPASy Server;
(In) John M. Walker (ed): The Proteomics Protocols Handbook, Humana Press (2005).
   Preferred proteases for use herein are selected from the group consisting of a metalloprotease, a cysteine protease, a neutral serine protease, an aspartate protease and mixtures thereof.

### Metalloproteases

Metalloproteases can be derived from animals, plants, bacteria or fungi. Suitable metalloprotease can be selected from the group of neutral metalloproteases and Myxobacter metalloproteases. Suitable metalloproteases can include collagenases, hemorrhagic toxins from snake venoms and thermolysin from bacteria. Preferred thermolysin enzyme variants include an M4 peptidase, more preferably the thermolysin enzyme variant is a member of the PepSY˜Peptidase_M4˜Peptidase_M4_C family.

Preferred metalloproteases include thermolysin, matrix metalloproteinases and those metalloproteases derived from Bacillus subtilis, Bacillus thermoproteolyticus, Geobacillus stearothermophilus or Geobacillus sp., or Bacillus amyloliquefaciens, as described in US PA 2008/0293610A1. A specially preferred metalloprotease belongs to the family EC3.4.24.27.

Further suitable metalloproteases are the thermolysin variants described in WO2014/71410. In one aspect the metalloprotease is a variant of a parent protease, said parent protease having at least 50% or 60%, or 80%, or 85% or 90% or 95% or 96% or 97% or 98% or 99% or even 100% identity to SEQ ID NO: 3 of WO 2014/071410 including those with substitutions at one or more of the following sets of positions versus SEQ ID NO: 3 of WO 2014/071410:
(a) 2, 26, 47, 53, 87, 91,96, 108, 118, 154, 179, 197, 198, 199, 209, 211, 217, 219, 225, 232, 256, 257, 259, 261, 265, 267, 272,276, 277, 286, 289, 290, 293, 295, 298, 299, 300, 301, 303, 305, 308, 311 and 316;
(b) 1, 4, 17, 25, 40, 45, 56, 58, 61, 74, 86, 97, 101, 109, 149, 150 , 158, 159, 172, 181, 214, 216, 218, 221, 222, 224, 250, 253, 254, 258, 263, 264, 266, 268, 271, 273, 275, 278, 279, 280, 282, 283, 287, 288, 291, 297, 302, 304, 307 and 312;
(c) 5, 9, 11, 19, 27, 31, 33, 37, 46, 64, 73, 76, 79, 80, 85, 89, 95, 98, 99, 107, 127, 129, 131, 137, 141, 145, 148, 151, 152, 155, 156, 160, 161, 164, 168 , 171, 176, 180, 182, 187, 188, 205, 206, 207, 210, 212, 213, 220, 227, 234 , 235, 236, 237, 242, 244, 246, 248, 249, 252, 255, 270, 274, 284, 294, 296, 306, 309, 310, 313, 314 and 315;
(d) 3, 6, 7, 20, 23, 24, 44, 48, 50, 57, 63, 72, 75, 81, 92, 93, 94, 100, 102, 103, 104, 110, 117, 120, 134, 135, 136, 140, 144, 153, 173, 174, 175, 178, 183, 185, 189, 193, 201, 223, 230, 238, 239, 241, 247, 251, 260, 262, 269, and 285;
(e) 17, 19, 24, 25, 31, 33, 40, 48, 73, 79, 80, 81, 85, 86, 89, 94, 109, 117, 140, 141, 150, 152, 153, 158, 159, 160, 161, 168, 171, 174, 175, 176, 178, 180, 181, 182, 183, 189, 205, 206, 207, 210, 212, 213, 214, 218, 223, 224,227, 235, 236, 237, 238, 239, 241, 244, 246, 248, 249, 250, 251, 252, 253, 254, 255, 258, 259, 260, 261, 262, 266, 268, 269, 270, 271, 272, 273, 274, 276, 278, 279, 280, 282, 283, 294, 295, 296, 297, 300, 302, 306, 310 and 312;
(f) 1, 2, 127, 128, 180, 181, 195, 196, 197, 198, 199, 211, 223, 224, 298, 299, 300, and 316 all relative to SEQ ID NO: 3 of WO 2014/071410.

Further suitable metalloproteases are the NprE variants described in WO2007/044993, WO2009/058661 and US 2014/0315775. In one aspect the protease is a variant of a parent protease, said parent protease having at least 45%, or 60%, or 80%, or 85% or 90% or 95% or 96% or 97% or 98% or 99% or even 100% identity to SEQ ID NO:3 of US 2014/0315775 including those with substitutions at one or more of the following sets of positions versus said sequence:

S23, Q45, T59, S66, 5129, F130, M138, V190, 5199, D220, K211, and G222,

Another suitable metalloprotease is a variant of a parent protease, said parent protease having at least 60%, or 80%, or 85% or 90% or 95% or 96% or 97% or 98% or 99% or even 100% identity to SEQ ID NO:3 of US 2014/0315775 including those with substitutions at one or more of the following sets of positions versus SEQ ID NO:3 of US 2014/0315775:
Q45E, T59P, 566E, S129I, S129V, F130L, M138I, V190I, S199E, D220P, D220E, K211V, K214Q, G222C, M138L/D220P, F130L/D220P, S129I/D220P, V190I/D220P, M138L/V190I/D220P, S129I/V190I, S129V/V190I, S129V/D220P, S129I/F130L/D220P, T004V/S023N, T059K/S66Q/S129I, T059R/S66N/S129I, S129I/F130L/M138L/V190I/D220P and T059K/S66Q/S129V.

Especially preferred metalloproteases for use herein belong belong to EC classes EC 3.4.22 or EC3.4.24, more preferably they belong to EC classes EC3.4.22.2, EC3.4.24.28 or EC3.4.24.27. The most preferred metalloprotease for use herein belong to EC3.4.24.27.
Suitable commercially available metalloprotease enzymes include those sold under the trade names Neutrase® by Novozymes A/S (Denmark), the Corolase® range including Corolase® 2TS, Corolase® N, Corolase® L10, Corolase® LAP and Corolase® 7089 from AB Enzymes, Protex 14L and Protex 15L from DuPont (Palo Alto, Calif.), those sold as thermolysin from Sigma and the Thermoase range (PC10F and C100) and thermolysin enzyme from

### Amano Enzymes.

The composition of the invention preferably comprises from 0.001 to 2%, more preferably from 0.003 to 1%, more preferably from 0.007 to 0.3% and especially from 0.01 to 0.1% by weight of the composition of active protease.

### Amylase

Amylases for use herein are preferably low temperature amylases. Compositions comprising low temperature amylases allow for a more energy efficient dishwashing processes without compromising in cleaning.

As used herein, “low temperature amylase” is an amylase that demonstrates at least 1.2, preferably at least 1.5 and more preferably at least 2 times the relative activity of the reference amylase at 25° C. As used herein, the “reference amylase” is the wild-type amylase of Bacillus licheniformis, commercially available under the tradename of Termamyl™ (Novozymes A/S). As used herein, “relative activity” is the fraction derived from dividing the activity of the enzyme at the temperature assayed versus its activity at its optimal temperature measured at a pH of 9.

Amylases include, for example, a-amylases obtained from Bacillus. Amylases of this invention preferably display some a-amylase activity. Preferably said amylases belong to EC Class 3.2.1.1.

Amylases for use herein, including chemically or genetically modified mutants (variants), are amylases possessing at least 60%, or 70%, or 80%, or 85%, or 90%, preferably 95%, more preferably 98%, even more preferably 99% and especially 100% identity, with those derived from Bacillus Licheniformis, Bacillus amyloliquefaciens, Bacillus sp. NCIB 12289, NCIB 12512, NCIB 12513, DSM 9375 (US 7,153,818) DSM 12368, DSMZ no. 12649, KSM AP1378 (WO 97/00324), KSM K36 or KSM K38 (EP 1 ,022,334). Suitable amylases include those derived from the sp. 707, sp. 722 or AA560 parent wild-types.
Preferred amylases include the variants of a parent amylase, said parent amylase having at least 60%, preferably 80%, more preferably 85%, more preferably 90%, more preferably 95%, more preferably 96%, more preferably 97%, more preferably 98%, more preferably 99% and specially 100% identity to SEQ ID NO:12 of WO2006/002643. The variant amylase preferably further comprises one or more substitutions and/or deletions in the following positions versus SEQ ID NO:12 of WO2006/002643:
9, 26, 30, 33, 82, 37, 106, 118, 128, 133, 149, 150, 160, 178, 182, 186, 193, 195, 202, 203, 214, 231, 256, 257, 258, 269, 270, 272, 283, 295, 296, 298, 299, 303, 304, 305, 311, 314, 315, 318, 319, 320, 323, 339, 345, 361, 378, 383, 419, 421, 437, 441, 444, 445, 446, 447, 450, 458, 461, 471, 482, 484 and preferably the variant amylase comprises the deletions in one or both of the 183 and 184 positions.

Preferred amylases comprise one or both deletions in positions equivalent to positions 183 and 184 of SEQ ID NO:12 of WO2006/002643.

Preferred commercially available amylases for use herein are STAINZYME®, STAINZYME PLUS®, STAINZYME ULTRA®, EVEREST® and NATALASE® (Novozymes A/S) and RAPIDASE, POWERASE® and the PREFERENZ S® series, including PREFERENZ S100® (DuPont).

The composition of the invention preferably comprises from 0.001 to 2%, more preferably from 0.003 to 1%, more preferably from 0.007 to 0.3% and especially from 0.01 to 0.1% by weight of the composition of active amylase.

### Enveloping Material

The pouch is made of enveloping material that is water soluble. By “water-soluble” is herein meant that the material has a water-solubility of at least 50%, preferably at least 75% or even at least 95%, as measured by the method set out herein after using a glass-filter with a maximum pore size of 20 microns.

50 grams+−0.1 gram of enveloping material is added in a pre-weighed 400 ml beaker and 245 ml+−1 ml of distilled water is added. This is stirred vigorously on a magnetic stirrer set at 600 rpm, for 30 minutes. Then, the mixture is filtered through a folded qualitative sintered-glass filter with a pore size as defined above (max, 20 micron). The water is dried off from the collected filtrate by any conventional method, and the weight of the remaining material is determined (which is the dissolved or dispersed faction). Then, the % solubility can be calculated.

The enveloping material is any water-soluble material capable of enclosing the cleaning composition of the product of the invention. The enveloping material can be a polymer that has been injection moulded to provide a casing or it can be a film. Preferably the enveloping material is made of polyvinyl alcohol. Preferably the enveloping material is a water-soluble film.

The pack can, for example, be obtained by injection moulding or by creating compartments using a film. The enveloping material is usually moisture permeable. The product of the invention is stable even when the enveloping material is moisture permeable. The first composition confers stability to the product, in terms of both interaction among the different compositions and interaction with the surrounding environment.

The enveloping material can be subjected to mechanical changes when exposed to moisture. The enveloping material can become brittle or too stretching when subjected to different moisture exposure conditions. The first composition contributes to the stabilization of the enveloping material.

Preferred substances for making the enveloping material include polymers, copolymers or derivatives thereof selected from polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum. More preferred polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and most preferably selected from polyvinyl alcohols, polyvinyl alcohol copolymers and hydroxypropyl methyl cellulose (HPMC), and combinations thereof. Especially preferred for use herein is polyvinyl alcohol and even more preferred polyvinyl alcohol films.

Most preferred enveloping materials are PVA films known under the trade reference Monosol M8630, as sold by Chris-Craft Industrial Products of Gary, Ind., US, and PVA films of corresponding solubility and deformability characteristics. Other films suitable for use herein include films known under the trade reference PT film or the K-series of films supplied by Aicello, or VF-HP film supplied by Kuraray.

The enveloping material herein may comprise other additive ingredients than the polymer or polymer material and water. For example, it may be beneficial to add plasticisers, for example glycerol, ethylene glycol, diethyleneglycol, propylene glycol, sorbitol and mixtures thereof. Preferably the enveloping material comprises glycerol as plasticisers. Other useful additives include disintegrating aids.

### EXAMPLES

Two pouches comprising low pH automatic dishwashing compositions (Compositions 1 and 2) were made. The pouches comprised a compartment comprising a liquid composition superposed onto a compartment comprising a solid composition. The enveloping material used to make the pouches was a polyvinyl alcohol water-soluble film, M8630 supplied by Monosol.

| Ingredient | Level (% wt) |
|---|---|
| Solid composition | 1 |
| Sodium citrate | 23 |
| 2-pyridinol-1-oxide | 3 |
| Citric acid | 19 |
| Sodium 1-hydroxyethyidene- | 4 |
| 1,1-diphosphonate | |
| Sodium percarbonate | 21 |
| Protease granule (8.8% active) | 4 |
| Amylase granule (1.4% active) | 4 |
| Processing Aids, fillers & minors | Balance to 100% |

A 1% solution of Composition 1 in deionsed water at room temperature had a pH of 6.5

| | Level ( % wt) | |
|---|---|---|
| | Liquid | |
| | composition | |
| Ingredient | 1 | 2 |
| Lutensol ® TO 7 (non-ionic surfactant | 34 | 34 |
| supplied by BASF) | | |
| Plurafac ® SLF180 (non-ionic surfactant | 28 | 28 |
| supplied by BASF) | | |
| Lutensol ® FP 620¹ | 18.75 | |
| Alkoxylated Polyethyleneimine² | | 25 |

| | |
|---|---|
| Processing Aids and dye | Balance to 100% |

¹Ethoxylated polyethyleneimine of formula (PEI600)/(EO)20 outside the scope of the invention
²Ethoxy/propoxy polyethyleneimine of formula (PEI600)/(EO/NH)11/(PO/NH)2/(EO/NH)8 inside the scope of the invention.

Test Stains

The test stains used were tea cups (Schönwald, 6-8 mm thick) soiled with black assam tea, prepared using the following procedure (taken from Methods for Ascertaining the Cleaning Performance of Dishwasher Detergents (Part B, updated 2005) from the IKW working group automatic dishwashing detergents):
1. Prepare 3 mmol Ca and Mg (16.8° d) water, pH7.5
2. Prepare ferric sulphate solution by adding 5 g Fe₂(SO₄)₃+1 ml HCl (37%) to one litre of demineralised water.
3. Add 0.1 ml of ferric sulphate to two litres of the 3 mmol water and bring to the boil.
4. Pour boiling water onto 30 g of black assam tea and leave to brew for five minutes.
5. After five minutes pour the tea through a strainer.
6. Fill the tea cup with 100 ml of the tea which should be around 93° C.
7. Remove 20 mls of tea every five minutes until the cup is empty.
8. This process is repeated once more with freshly brewed tea.
9. The soiled cups are stored for at least three days at room temperature and humidity.

Additional Ballast Soil 1

To add extra soil stress to the test, a blend of soils is added to the dishwasher, as prepared by the procedure described below

| Ingredient | % content |
|---|---|
| Potato Starch | 5.6 |
| Wheat Flour | 4.5 |
| Vegetable oil | 4.4 |
| Margarine | 4.4 |
| Lard | 4.4 |
| Single Cream | 9.0 |
| Baking Spread | 4.4 |
| Large Eggs | 9.0 |
| Whole Milk | 9.0 |
| Ketchup | 3.0 |
| Mustard | 4.0 |
| Benzoic acid >99% | 0.8 |
| Water (15-18 grains | |
| per US gallon) | 37.5 |
| Total | 100 |

### Soil Preparation

1. Add water to the potato starch and leave to soak overnight. Then heat in a pan until the gel formed is properly inflated. Leave the pan to cool at room temperature overnight.
2. Weigh out the appropriate amounts of each ingredient.
3. Add the Ketchup and mustard to a bowl and mix vigorously until fully combined, 1 minute.
4. Melt Margarine, lard and baking spread individually in a microwave and allow to cool to room temperature then mix together.
5. Add Wheat Flour and Benzoic acid to a bowl and mix vigorously.
6. Break eggs into a bowl and mix vigorously.
7. Add vegetable oil to the eggs and stir using a hand blender.
8. Mix the cream and milk in a bowl.
9. Add all of the ingredients together into a large container and mix using a blender for ten minutes.
10. Weigh out 50 g batches of this mixture into plastic pots and freeze.

Additional Ballast Soil 2
To add extra soil stress to the test, a blend of soils is added to the dishwasher, as prepared by the procedure described below

| Ingredient | % content |
|---|---|
| Lean Minced Pork | 29.6 |
| Lean Minced Beef | 29.6 |
| Egg | 19.7 |
| Water | 21.1 |
| Total | 100 |

### Soil Preparation

1. Weigh out the appropriate amounts of each ingredient.
2. Whisk eggs.
3. Add minced meat to whisked eggs and mix using a blender for ten minutes.
4. Add water and blend for a further five minutes.
5. Weigh out 36g batches of this mixture into plastic pots and freeze.

V. Test Wash Procedure
Automatic Dishwasher: Miele, model GSL
Wash volume: 5000 ml
Water temperature: 50° C.
Water hardness: 23 grains per US gallon
Detergent addition: Added into the bottom of the automatic dishwasher after the initial pre-wash is complete.
Additional ballast bottom rack: 12× dinner plates 6× side plates
Additional ballast top rack: 6× deep dishes 4× tea cups
Positioning of tea cups: Top rack; 1× front left, 1× back right.
Additional soil stress: 2× 50 g pots of Additional ballast soil 1 added to bottom rack.
   1× 36 g pot of Additional ballast soil 2 added to top rack.

### Example 1

One pouch, comprising as below, was added to the automatic dishwasher.

| Example | Composition |
|---|---|
| Formula A | 14 g Solid composition 1 + |
| | 4 g liquid composition 1 |
| Formula B | 14 g Solid composition 1 + |
| | 4 g liquid composition 2 |

A dishwasher was loaded with the above items which were washed using Formulas A and B respectively in soft water as detailed above. The items and the items were then graded on a visual scale of 1-10 where 1 is no removal and 10 is full removal of the tea soil.

| | Tea Cleaning Grade | Error |
|---|---|---|
| Formula A | 7.5 | ±1 |
| Formula B | 7.75 | ±1 |

As can be seen the two Formulas deliver similar tea cleaning performance.

The stability of the liquid composition according to the invention was compared with the stability of a liquid comprising an alkoxylated polyalkylenimine outside the scope of the invention.

| Liquid | | | |
|---|---|---|---|
| composition | | | |
| Material | | Actual Weight (g) | |
| DPG | | 50.9 | |
| Glycerol | | 16.3 | |
| SLF180 | | 23 | |
| Plurafac 7319 | | 79.4 | |
| TO7 | | 123.3 | |
| Perfume | | 7.0 | |
| | Batch 1 | Batch 2 | Batch 3 |
| Premix | 86.8 | 86.5 | 86.7 |
| PEI1 | 11.4 | | 11.3 |
| PEI2 | | 13.9 | |
| PEI1 | | | |
| Water | | | 2.8 |
| eRH | 29.10% | 44.40% | 46.10% |
| at25deg C. | | | |
| | No-phase | Phase | Phase |
| | separation | separation | separation |

PEI1: Ethoxy/propoxy polyethyleneimine of formula (PEI600)/(EO/NH)11/(PO/NH)2/(EO/NH)8
PEI2: Ethoxylated polyethyleneimine of formula (PEI600)/(EO20)

A liquid composition comprising the alkoxylated polyalkylenimine of the invention is stable and it does not separate. This is not the case with a liquid composition comprising an alkoxylated polyalkylenimine outside the scope of this invention.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A pouch comprising a cleaning composition, the pouch comprising a compartment housing a liquid composition, the liquid composition comprising a liquid soil-suspension polymer wherein the soil-suspension polymer is an a alkoxylated polyalkylenimine of the general formula I 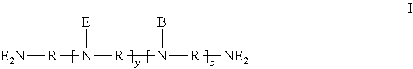
in which the variables are each defined as follows:
R represents identical or different, linear or branched C₂-C₁₂-alkylene radicals, preferably ethylene or hexamethylene, or an
etheralkyl unit of formula X:
—R¹⁰O—R¹¹_{d}O—R¹²— X
in which the variables are each defined as follows:
R¹⁰, R¹¹, R¹² represent identical or different, linear or branched C₂-C₆-alkylene radicals and d is an integer having a value in the range of from 0 to 50;
B represents a continuation of the alkoxylated polyalkylenimine by branching;
y is from 0 to 150, z is greater than 0 and less than or equal to 150, and the sum of y+z is at least 1;
E is an alkylenoxy unit of the formula II
CH₂CH₂OₘR¹—OₙCH₂CH₂OₚR² II
in which the variables are each defined as follows:
R¹ represents 1,2-propylene, 1,2-butylene and/or 1,2-pentene;
R² represents hydrogen and/or C₁-C₂₂-alkyl and/or C₇-C₂₂ aralkyl;
m is an integer having a value in the range of from 5 to 18;
n is an integer having a value in the range of from 1 to 5;
p is an integer having a value in the range of from 2 to 14.

2. A pouch according to claim 1 wherein the alkoxylated polyalkyleneamine comprises a polyalkylenamine that, before alkoxylation, has a weight average molecular weight (Mw) of from about 250 to about 10 000 g/mol.

3. A pouch according to claim 1 wherein m+p is equal to or greater than 14.

4. A pouch according to claim 1 wherein the degree of quaternization of the nitrogen atoms present in the polyalkylenimine is in the range of from about 10% to about 95%.

5. A pouch according to claim 1 wherein the liquid composition has an equilibrium relative humidity of less than about 65% at 20° C.

6. A pouch according to claim 1 wherein the cleaning composition has a pH as measured in 1% weight aqueous solution at 25° C. of from about 5 to about 7.5

7. A pouch according to claim 1 wherein the liquid composition further comprises a surfactant system and wherein the surfactant system comprises an esterified alkyl alkoxylated surfactant of general formula (I) 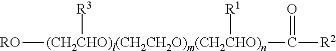
wherein
R is a branched or unbranched alkyl radical having 8 to 16 carbon atoms;
R³, R¹ independently of one another, are hydrogen or a branched or unbranched alkyl radical having 1 to 5 carbon atoms;
R² is an unbranched alkyl radical having 5 to 17 carbon atoms; l, n independently of one another, are a number from 1 to 5 and m is a number from 13 to 35.

8. A pouch according to claim 1 further comprising a surfactant system and wherein the surfactant system comprises:
a) a non-ionic surfactant of formula RO(CH2CH2O)xH wherein where R is iso-C13H27 and x is 7; and
b) a non-ionic surfactant of formula RO(CH2CH2O)x(CH2CH2CH2O)yH wherein where R is a C6-C14 alkyl and x and y are from 5 to 20.

9. A pouch according to claim 1 comprising a surfactant system wherein the surfactant system and the soil-suspension polymer in the liquid composition are in a weight ratio of from about 5:1 to about 1:1.

10. A composition according to claim 1 wherein the composition is an automatic dishwashing composition.

11. A pouch according to claim 1 further comprising a compartment housing a phosphate free solid composition wherein the solid composition comprises a moisture-sensitive ingredient.

12. A pouch according to claim 1 comprising a moisture-sensitive ingredient wherein the moisture-sensitive ingredient is selected from the group consisting of bleach, enzymes and mixtures thereof.

13. A pouch according to claim 1 wherein the cleaning composition is builder free.

14. A pouch according to claim 1 comprising bleach wherein the level of bleach is from about 1% to about 40% by weight of the composition wherein the bleach is placed in the solid composition.
